(19) United States
(12) Patent Application Publication
(10) Pub. No.: US 2026/0235937 A1
(43) Pub. Date: Aug. 13, 2026

(54) CAMERA QUICK RELEASE SYSTEM

(71) Applicant: IP MILL HOLDINGS LLC, Simi Valley, CA (US)

(72) Inventor: Filip Postolek, Simi Valley, CA (US)

(21) Appl. No.: 19/147,995

(22) PCT Filed: Jan. 12, 2024
(86) PCT No.: PCT/US2024/011367

§ 371 Date: Jul. 14, 2025

Related U.S. Application Data
(60) Provisional application No. 63/439,084, filed on Jan. 14, 2023.

(51) Int. Cl. G03B 17/56; A45F 5/00; A45F 5/02; F16M 11/04; F16M 11/08; F16M 13/04

(52) U.S. Cl. CPC G03B 17/561; A45F 5/021; A45F 5/1533; F16M 11/041; F16M 11/08; F16M 13/04; A45F 2005/006

(57) ABSTRACT

A quick-release system is for connecting a camera with an object, such as a strap. The system may include a first adapter adapted for connecting to the camera and a second adapter for forming a releasable locking engagement with the first adapter. The second adapter may include at least one aperture for receiving a fastener for connecting to the object. A coupler connects the second adapter to the strap. For a camera, the system includes an object for which connection to the camera is desirable, along with a first 2024/151928 adapter for connecting to the camera and a second adapter for forming a releasable locking engagement with the first adapter, the second adapter including: (1) at least one aperture for receiving a fastener for connecting to the object; (2) at least three apertures for receiving fasteners for connecting to the second adapter to the object or the strap; or (3) a second threaded aperture repeating the functionality of the first threaded aperture of the camera.

WO

This application claims the benefit of U.S. Provisional Patent Application Ser. No. 63/439,084, filed Jan. 14, 2023, and is related to U.S. Provisional Patent Application Ser. No. 62/419,261 and U.S. Patent No. 10761412B1, the disclosures of all of which are incorporated herein by reference.

### TECHNICAL FIELD

This disclosure relates generally to cameras and, more particularly, to a system for connecting a camera to an object for ready use by a photographer, while also allowing for quick release for use independent of the object.

### BACKGROUND

Photographers require ready access to their cameras in order to capture the perfect shot. Often, cameras are provided with neck straps for this purpose. These straps can get in the way, especially when the photographer is also wearing an item of baggage, such as a camera bag, and in extreme situations might interfere with the intended use of the camera.

Accordingly, it would be desirable to provide an apparatus for quickly connecting and releasing a camera from a strap or other object for independent use.

### SUMMARY

An object of this disclosure is to provide a system for quickly connecting and releasing a camera from a strap or other object for independent use.

In one aspect, this disclosure relates to a quick-release system for connecting a camera with an object or a strap. The system includes a first adapter adapted for connecting to the camera and a second adapter adapted for forming a releasable locking engagement with the first adapter. The second adapter includes at least one aperture for receiving a fastener for connecting to the object. A coupler is provided for connecting the second adapter to the strap.

In one embodiment, fasteners are provided for connecting the coupler to the second adapter to form a channel for receiving the strap. The coupler and second adapter may be adapted for frictionally engaging the strap. The first adapter may comprise a slot for receiving a fastener for connecting with the camera.

The first adapter may be adapted for sliding into a recess of the second adapter in a first direction and being captured against movement in any other direction besides the first direction when located therein. The second adapter may comprise at least three apertures adapted for receiving fasteners for connecting to the second adapter to the object or the strap. Two of the at least three apertures are for connecting to a coupler for forming a channel with the second adapter for engaging the strap, and a third aperture is for connecting to the object. At least one, and possibly each, of the at least three apertures may be internally threaded.

According to a further aspect of the disclosure, a quick-release system for connecting a camera is provided. The system includes an object for which connection to the camera is desirable. A first adapter is adapted for connecting to the camera. A second adapter is adapted for forming a releasable locking engagement with the first adapter. The second adapter includes at least one aperture for receiving a fastener for connecting to the object.

In one embodiment, the object comprises a tripod. In another embodiment, the object comprises a ring adapted for connecting to a strap. In still another embodiment, the object comprises a holster connected to a belt. In yet a further embodiment, the object includes a strap, and further including a coupler, such as a swivel connector, for connecting the second adapter to a strap.

In these or other embodiments, the second adapter comprises at least three apertures adapted for receiving fasteners for connecting to the second adapter to the object or a strap. The at least three apertures may be adapted for receiving fasteners for connecting to the second adapter to the object or the strap. Two of the at least three apertures are for connecting to a coupler for forming a channel with the second adapter for engaging the strap, and a third aperture is for connecting to the object. At least one, and possibly each, of the at least three apertures may be internally threaded.

A further aspect of the disclosure relates to a quick-release system for connecting a camera to an object or a strap. The system includes a first adapter adapted for connecting to the camera. A second adapter is adapted for forming a releasable locking engagement with the first adapter. The second adapter includes at least three apertures adapted for receiving fasteners for connecting to the second adapter to the object or the strap.

In one embodiment, two of the at least three apertures are for connecting to a coupler for forming a channel with the second adapter for engaging the strap, and a third aperture is for connecting to the object. At least one, and possibly each, of the at least three apertures is internally threaded.

Still a further aspect of this disclosure is a quick-release system for connecting a camera with an object. The system includes a first adapter adapted for connecting to the camera using a first thumb screw and a second adapter adapted for forming a releasable locking engagement with the first adapter. The second adapter includes at least one aperture for receiving a second thumb screw for connecting the second adapter to the object.

Yet another aspect of this disclosure relates to a quick-release system for a camera including a first threaded aperture for receiving a first fastener. The system further includes a first part adapted connecting to the camera via the first fastener and a second part adapted for forming a releasable locking engagement with the first part, the second part including a second threaded aperture repeating the functionality of the first threaded aperture of the camera.

In one embodiment, the first and second apertures are aligned. The first and second apertures may have a common axis. A coupler may also be provided for connecting the second part to a strap.

### BRIEF DESCRIPTION OF THE DRAWING FIGURES

While the specification concludes with claims which particularly point out and distinctly claim this technology, it is believed this technology may be better understood from the following description of certain examples taken in conjunction with the accompanying drawings, in which like reference numerals identify the same elements and in which:

FIG. 1 depicts a perspective view of a camera quick-release system according to tis disclosure;

FIG. 1A is an exploded view of the camera quick-release system of FIG. 1;

FIGS. 1B, 1C, 1D, and 1E are top, front, bottom and rear views of the camera quick-release system of FIG. 1;

FIG. 2 is a perspective view of one component of the camera quick-release system of FIG. 1;

FIGS. 2A and 2B and top and bottom views of the component of FIG. 2;

FIG. 3 is a perspective view of another component of the camera quick-release system of FIG. 1;

FIGS. 3A and 3B and top and bottom views of the component of FIG. 3;

FIGS. 4 and 5 are progressive views showing the assembly of the camera quick-release system of FIG. 1;

FIG. 6 is a perspective view of another component of the camera quick-release system of FIG. 1;

FIGS. 6A, 6B, 6C, and 6D are top, front, bottom, and rear views of the component of FIG. 6;

FIGS. 7 and 8 are progressive views showing possible uses of the camera quick-release system of FIG. 1;

FIGS. 9 and 10 are progressive views showing other possible uses of the camera quick-release system of FIG. 1;

FIGS. 11 and 12 are progressive views showing other possible uses of the camera quick-release system of FIG. 1.

FIGS. 13 and 14 are progressive views showing other possible uses of the camera quick-release system of FIG. 1.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown.

### DETAILED DESCRIPTION

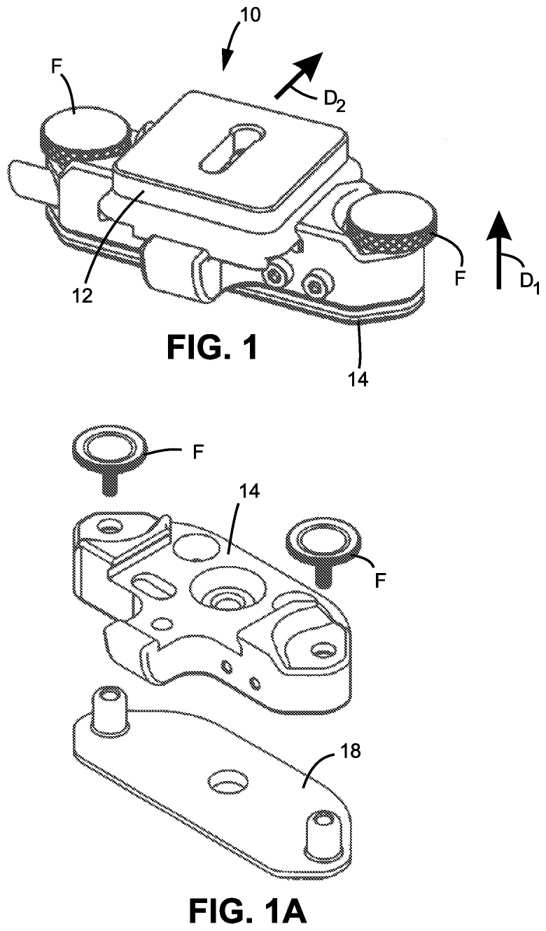

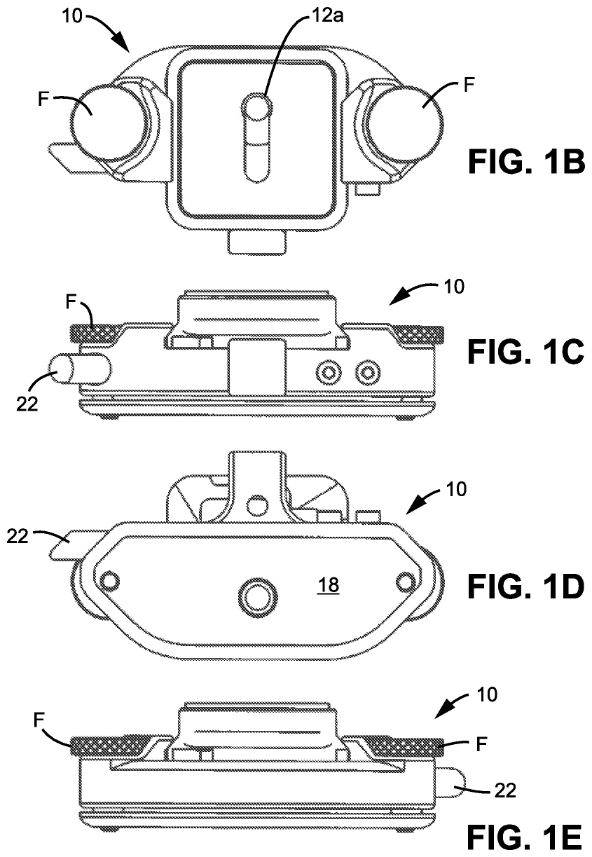

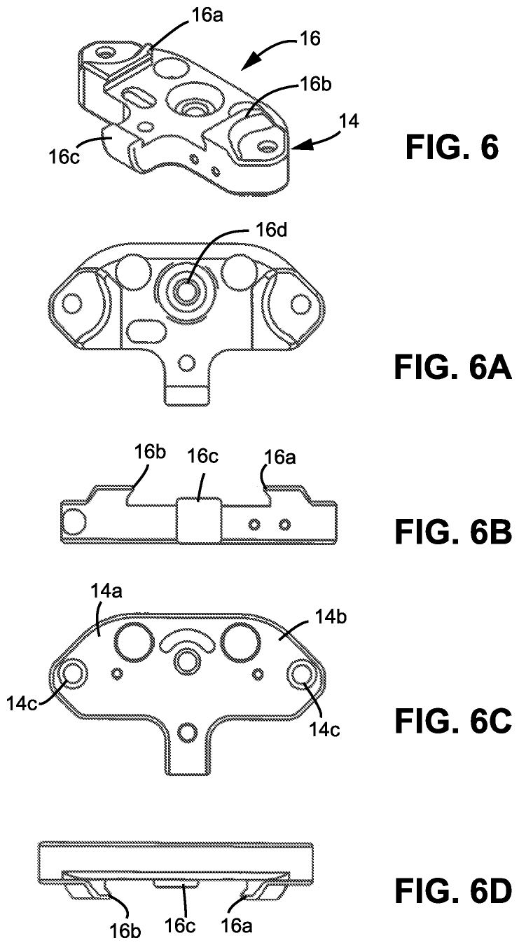

With reference now to FIGS. 1, 1A, 1B, 1C, 1D, and 1E a quick-release system 10 for mounting a camera to one or more objects is disclosed. The system 10 comprises a first adapter 12 for connecting to the camera and a second adapter 14 for connecting both with the first adapter and an object (such as for example a ring R; see FIG. 6) or a coupler 18 for connecting to a strap, which may be associated with a bag or pack (as shown in FIG. 12, but it could be an independent item as well). The object to which the second adapter 14 connects may also be the pack or bag itself, as understood from the following description.

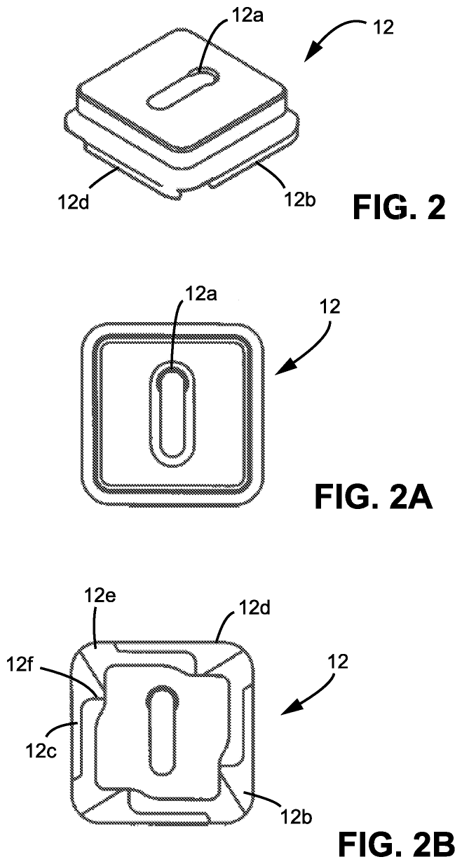

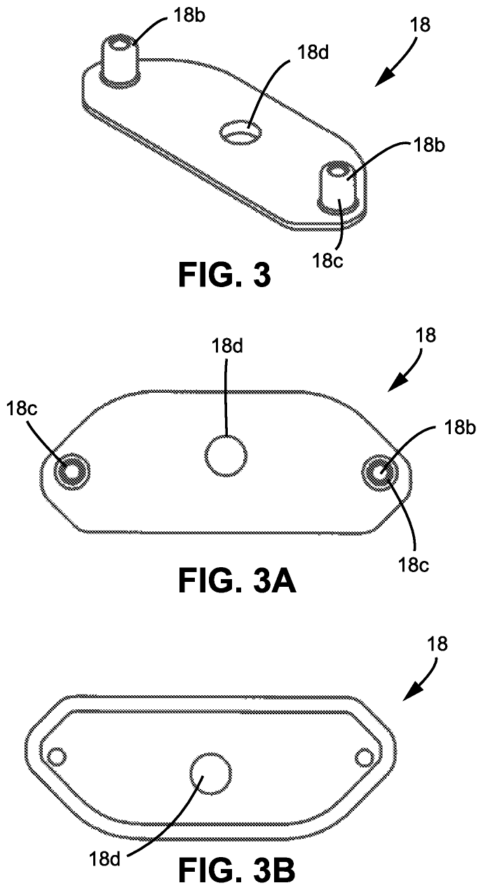

Turning to FIGS. 2, 4, and 5, the first adapter 12 is adapted to connect to both a camera C and the second adapter 14. To achieve the former, the first adapter 12 may comprise an opening, such as a slot 12a, for receiving a fastener for connecting to the camera, such as a conventional thumb screw S. The slot 12a may be formed in and through an upper planar portion of the first adapter 12 for seating against an underside surface of the camera C when fastened thereto.

To achieve the latter, the first adapter 12 is adapted to slidably receive, engage and release from the second adapter 14. As perhaps best shown in FIGS. 6, 6A, 6B, 6C, and 6D, the second adapter 14 includes a receiver 16 or recess adapted for receiving the first adapter 12. The receiver 16 includes opposed overhangs 16a, 16b forming a channel for capturing chamfered portions 12b, 12c the first adapter 12 against separation in one direction, such as vertical in the illustrated orientation of FIG. 1, but allowing for insertion and removal in a second direction, such as horizontal. The receiver 16 also includes a stop 16c for fixing the amount of forward movement of the first adapter in the second direction. The first adapter 12 may also include a chamfered portion 12d for engaging and seating in a similarly recessed portion of the stop 16c.

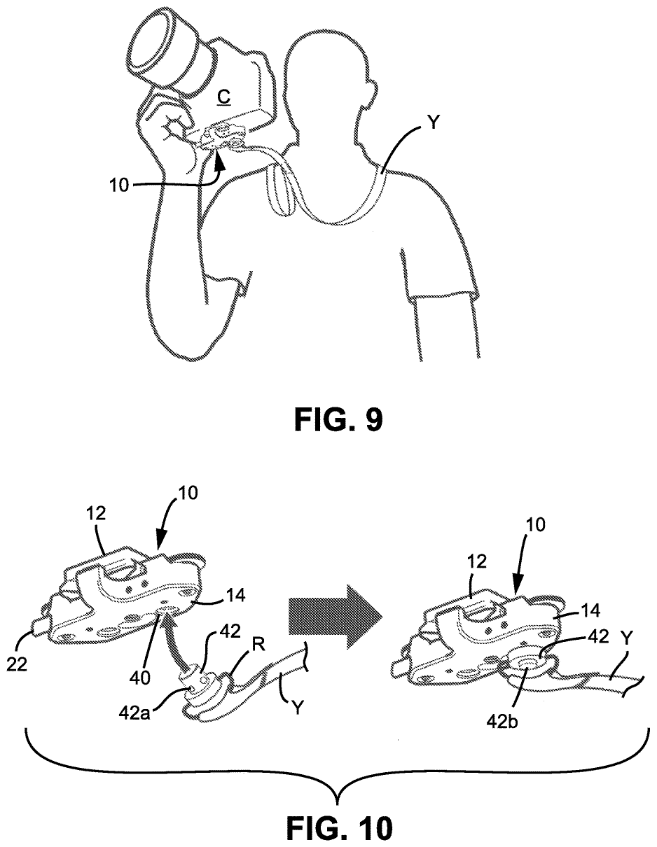

With reference to FIGS. 1A and 9, the second adapter 14 may also be adapted to connect with the coupler 18 as noted above. Specifically, with further reference to FIG. 6C, the second adapter 14 may include wings 14a, 14b, each including an aperture or opening 14c for receiving a fastener F. The openings 14c may be adapted to align with corresponding openings 18a, 18b formed in the coupler 18, which may be formed in standoffs 18c. One or both of these openings 18a, 18b may be internally threaded for engaging the fasteners F, which may comprise removable thumb screws.

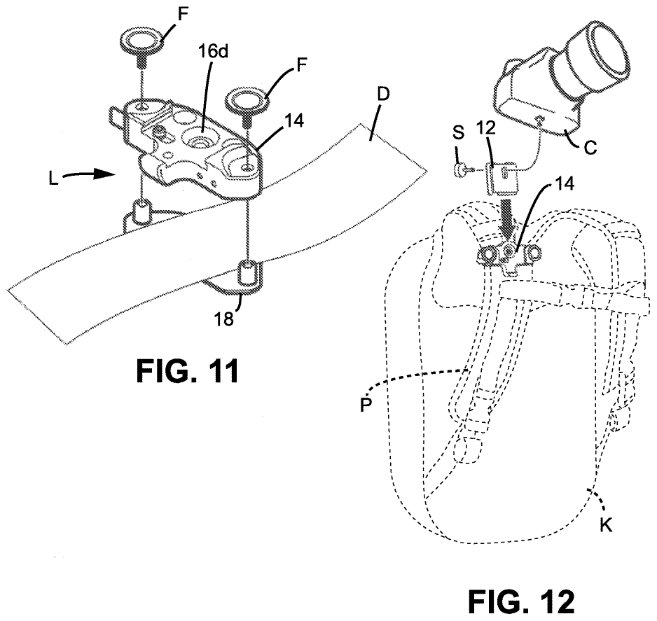

When the second adapter 14 and coupler 18 are thus connected, a channel L or passage is formed for capturing and surrounding a thin object, such as a flexible strap (see FIG. 11). Opposing surfaces of the second adapter 14 and coupler 18 may be adapted to engage the strap, such as by way of friction, to aid in holding the assembly in position thereupon. Aligned openings 16d, 18d having an axis in common with the aperture or opening (slot 12a) in first adapter 12 may also be provided in the second adapter 14 and coupler 18 to allow for a thumb screw S to pass through both, as well as the first adapter 12 when connected to the second adapter 14 (which connection may use a different screw and connect to camera C). One or both of the openings 16d, 18d may be internally threaded for engaging corresponding threads of the screw(s) S, but opening 18d may be oversized to simply allow the fastener to pass into engagement with the opening 16d in the second adapter.

As can be appreciated, the openings 16d, 18d may thus establish one or both of corresponding parts 14, 18 as a repeater of the functionality of the first adapter 12 in terms of receiving a threaded fastener, such as in that case for connecting with the camera C, but in the case of the second adapter 14 or coupler 18, connecting with an object (such as a tripod or ring, as outlined below). This allows for the second adapter 14 to be connected to the object without the need for removing the first adapter 12 from a mounted condition on the camera C.

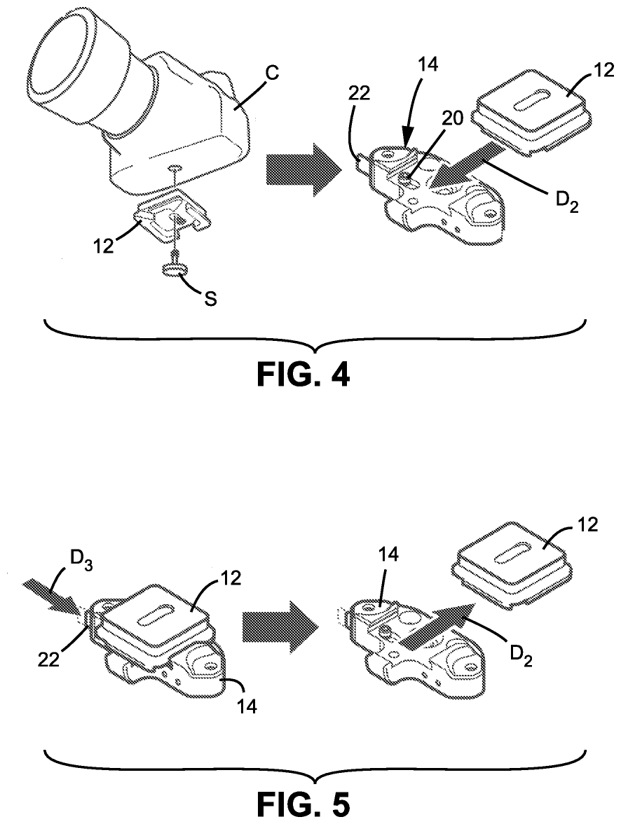

Turning now to FIGS. 4 and 5, it can also be understood that the first adapter 12 and second adapter 14 may be adapted to form a releasable interlocking engagement. Specifically, the second adapter 14 may include a laterally movable connector (direction D3), such as an upstanding pin 20 within the receiver 16. The pin 20 is attached to an actuator, such as an external button 22, that biases the pin 20 to a home position (such as via a spring, not shown). The first adapter 12 includes an opening 12e in a forward portion thereof, such as adjacent to the front chamfered portion 12d, adapted to receive the pin 20 when moved from the home position to a deployed position (or vice-versa if the button 22 functioned as a pull). Once the second adapter 14 is inserted into the recess 16, the button 22 may be released to allow the pin 20 to return to the home position, at which point it is captured in place by a projection 12f formed in the underside of the first adapter.

Thus, as can be understood from the sequence shown in FIG. 5, the first adapter 12 may be secured to the camera C by the screw S or like fastener. Either before or after, the second adapter 14 may be connected to the first adapter 12, such as by depressing the button 22 to move the pin 20 to the deployed position, sliding the first adapter 12 into the recess 16 in the direction D2, and then releasing the button 22 to establish the locking engagement between the first adapter 12 and the pin 20. Reversing this sequence allows for the adapters 12, 14 to be separated in direction D2, thus establishing a quick-release mechanism.

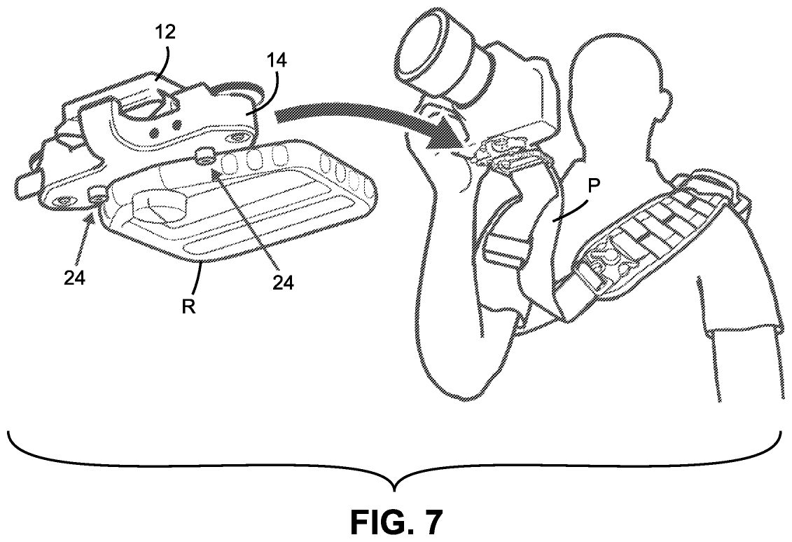

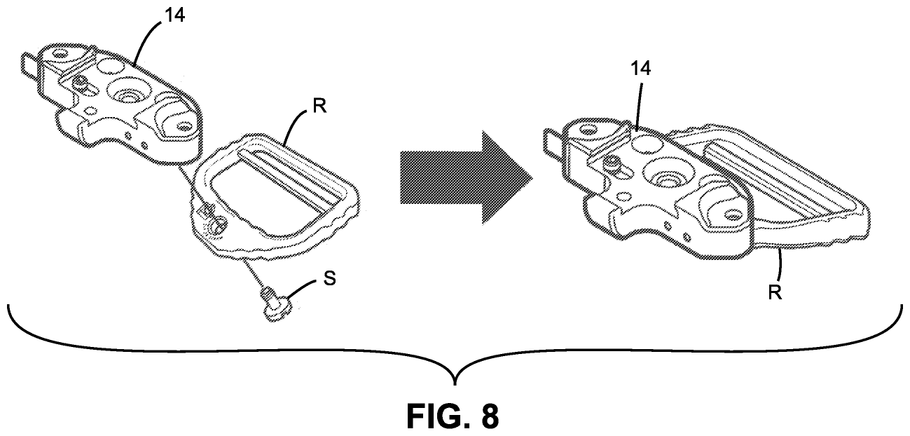

In the assembled condition, the first and second adapters 12, 14 may then be connected to an object, such as the ring R shown in FIGS. 7 and 8. The ring R may be of the D-ring type, as shown and described in U.S. Patent No. 10761412B1, and thus may be adapted to form a buckle for connecting to a strap S. The connection may be made using a screw S, which could be the same screw for connecting with the camera C, or could be a different screw (but of similar construction—e.g., ¼″-20 screw). To resist relative rotation, the second adapter 14 may also be provided with one or more depending projections 24 for engaging a corresponding surface of the ring R.

Versatility and ease of use are the hallmarks of the proposed adapter system 10. Instead of a ring R, it can be understood from FIGS. 11 and 12 that the second adapter 14 and coupler 18 may be used together to connect to a strap P or webbing, which may be associated with a pack K. This can be done by using fasteners F to “sandwich” these parts over the strap P. The camera C may be easily connected or disconnected by inserting or removing the first adapter 12.

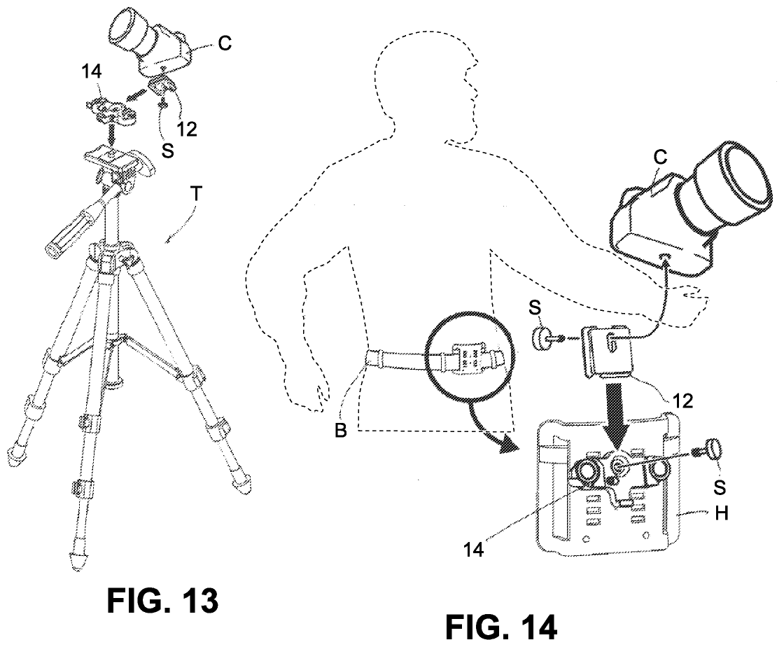

Likewise, as shown in FIG. 13, the system 10 can alternatively be used to connect a camera C to other objects. For example, a fastener, such as similar to screw S, may be used to connect the camera C to a tripod T (with which the fastener may be associated). Similarly, such a fastener may be used to connect the camera to a holster H, such as one associated with a belt B worn by a user, as shown in FIG. 1.

FIGS. 9 and 10 illustrate a modification in which the system 10 and, in particular, the second adapter 14, is provided with a receiver 40 for receiving a coupler, such as a swivel connector 42 with detents 42a and an actuator button 42b, which may be connected to a wearable object, such as a strap or lanyard Y. This allows for the system 10 to readily and releasably connect to the object, and provides for multiple points of detachment (either using actuator (button 22) or the connector 42). A suitable ring R may be used to connect the connector 42 to the lanyard Y.

The parts of the system 10 may be fabricated of metal, plastic, or combinations thereof, and may be multiple pieces or a single unitary piece of material. The fastener, such as screw S, is typically made of metal as well, but could be hardened plastic. While the strap P would typically be a woven polymer material, such as nylon, it could also be formed of other non-woven materials, such as for example rubber, leather, plastic, or any combination thereof.

Summarizing, this disclosure may relate to any one or a combination of the following items:
1. A quick-release system for connecting a camera with an object or a strap, comprising:
a first adapter adapted for connecting to the camera;
a second adapter adapted for forming a releasable locking engagement with the first adapter, the second adapter including at least one aperture for receiving a fastener for connecting to the object; and
a coupler for connecting the second adapter to the strap.
2. The system of item 1, further including fasteners for connecting the coupler to the second adapter to form a channel for receiving the strap.
3. The system of item 1 or item 2, wherein the coupler and second adapter are adapted for frictionally engaging the strap.
4. The system of any of items 1-3, wherein the first adapter comprises a slot for receiving a fastener for connecting with the camera.
5. The system of any of items 1-4, wherein the first adapter is adapted for sliding into a recess of the second adapter in a first direction and being captured against movement in any other direction besides the first direction when located therein.
6. The system of any of items 1-5, wherein the second adapter comprises at least three apertures adapted for receiving fasteners for connecting to the second adapter to the object or the strap.
7. The system of any of items 1-6, wherein two of the at least three apertures are for connecting to a coupler for forming a channel with the second adapter for engaging the strap, and a third aperture is for connecting to the object.
8. The system of items 1-7, wherein at least one of the at least three apertures is internally threaded.
9. The system of any of items 1-8, wherein each of the at least three apertures is internally threaded.
10. A quick-release system for connecting a camera, comprising:
an object for which connection to the camera is desirable;
a first adapter adapted for connecting to the camera;
a second adapter adapted for forming a releasable locking engagement with the first adapter, the second adapter including at least one aperture for receiving a fastener for connecting to the object.
11. The system of item 10, wherein the object comprises a tripod.
12. The system of item 10 or item 11, wherein the object comprises a ring adapted for connecting to a strap.
13 The system of any of items 10-12, wherein the object comprises a holster connected to a belt.
14. The system of any of items 10-13, wherein the object includes a strap, and further including a coupler for connecting the second adapter to a strap.
15. The system of claim 14, wherein the coupler comprises a swivel connector.
16. The system of any of items 10-15, wherein the second adapter comprises at least three apertures adapted for receiving fasteners for connecting to the second adapter to the object or a strap.
17. The system of item 16, wherein the at least three apertures are adapted for receiving fasteners for connecting to the second adapter to the object or the strap.
18. The system of item 16, wherein two of the at least three apertures are for connecting to a coupler for forming a channel with the second adapter for engaging the strap, and a third aperture is for connecting to the object.
19. The system of item 16, wherein at least one of the at least three apertures is internally threaded.
20 The system of item 16, wherein each of the at least three apertures is internally threaded.
21. A quick-release system for connecting a camera to an object or a strap, comprising:
a first adapter adapted for connecting to the camera; and
a second adapter adapted for forming a releasable locking engagement with the first adapter, the second adapter including at least three apertures adapted for receiving fasteners for connecting to the second adapter to the object or the strap.
22. The system of item 21, wherein two of the at least three apertures are for connecting to a coupler for forming a channel with the second adapter for engaging the strap, and a third aperture is for connecting to the object.
23. The system of item 21 or item 22, wherein at least one of the at least three apertures is internally threaded.
24. The system of any of items 21-23, wherein each of the at least three apertures is internally threaded.
25. A quick-release system for connecting a camera with an object, comprising:
a first adapter adapted for connecting to the camera using a first thumb screw; and
a second adapter adapted for forming a releasable locking engagement with the first adapter, the second adapter including at least one aperture for receiving a second thumb screw for connecting the second adapter to the object.
26 A quick-release system, comprising:
a camera including a first threaded aperture for receiving a first fastener;
a first part adapted connecting to the camera via the first fastener;
a second part adapted for forming a releasable locking engagement with the first part, the second part including a second threaded aperture repeating the functionality of the first threaded aperture of the camera.
27. The system of item 26, wherein the first and second apertures are aligned.
28. The system of item 26 or item 27, wherein the first and second apertures have a common axis.
29. The system of any of items 26-28, further including a coupler adapted for connecting the second part to a strap.

Each of the following terms written in singular grammatical form: “a”, “an”, and the”, as used herein, means “at least one”, or “one or more”. Use of the phrase ”One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or the context clearly dictates otherwise. For example, the phrases: “a unit”, “a device”, “an assembly”, “a mechanism”, “a component, “an element”, and “a step or procedure”, as used herein, may also refer to, and encompass, a plurality of units, a plurality of devices, a plurality of assemblies, a plurality of mechanisms, a plurality of components, a plurality of elements, and, a plurality of steps or procedures, respectively.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated components), feature(s), characteristic(s), parameter(s), integer(s), or step(s), and does not preclude addition of one or more additional component(s), feature(s), characteristic(s), parameter(s), integer(s), step(s), or groups thereof. Each of these terms is considered equivalent in meaning to the phrase “consisting essentially of.” Each of the phrases “consisting of” and “consists of, as used herein, means “including and limited to”. The phrase “consisting essentially of” means that the stated entity or item (system, system unit, system sub-unit device, assembly, sub-assembly, mechanism, structure, component element or, peripheral equipment utility, accessory, or material, method or process, step or procedure, sub-step or sub-procedure), which is an entirety or part of an exemplary embodiment of the disclosed invention, or/and which is used for implementing an exemplary embodiment of the disclosed invention, may include at least one additional feature or characteristic” being a system unit system sub-unit device, assembly, sub-assembly, mechanism, structure, component or element or, peripheral equipment utility, accessory, or material, step or procedure, sub-step or sub-procedure), but only if each such additional feature or characteristic” does not materially alter the basic novel and inventive characteristics or special technical features, of the claimed item.

Terms of approximation, such as the terms about, substantially, approximately, generally, etc., as used herein, refer to ±10% of the stated numerical value or as close as possible to a stated condition.

It is to be fully understood that certain aspects, characteristics, and features, of the invention, which are, for clarity, illustratively described and presented in the context or format of a plurality of separate embodiments, may also be illustratively described and presented in any suitable combination or sub-combination in the context or format of a single embodiment. Conversely, various aspects, characteristics, and features, of the invention which are illustratively described and presented in combination or sub-combination in the context or format of a single embodiment may also be illustratively described and presented in the context or format of a plurality of separate embodiments.

Although the invention has been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A quick-release system for connecting a camera with an object or a strap, comprising:
a first adapter adapted for connecting to the camera;
a second adapter adapted for forming a releasable locking engagement with the first adapter, the second adapter including at least one aperture for receiving a fastener for connecting to the object; and
a coupler for connecting the second adapter to the object or the strap.

2. The system of claim 1, further including fasteners for connecting the coupler to the second adapter to form a channel for receiving the object or the strap.

3. The system of claim 1, wherein the coupler and second adapter are adapted for frictionally engaging the object or the strap.

4. The system of claim 1, wherein the first adapter comprises a slot for receiving a fastener for connecting with the camera.

5. The system of claim 1, wherein the first adapter is adapted for sliding into a recess of the second adapter in a first direction and being captured against movement in any other direction besides the first direction when located therein.

6. The system of claim 1, wherein the second adapter comprises at least three apertures adapted for receiving fasteners for connecting to the second adapter to the object or the strap.

7. The system of claim 6, wherein two of the at least three apertures are for connecting to a coupler for forming a channel with the second adapter for engaging the strap, and a third aperture is for connecting to the object.

8. The system of claim 6, wherein at least one of the at least three apertures is internally threaded.

9. (canceled)

10. A quick-release system for connecting a camera, comprising:
an object for which connecting to the camera;
a first adapter adapted for connecting to the camera;
a second adapter adapted for forming a releasable locking engagement with the first adapter, the second adapter including at least one aperture for receiving a fastener for connecting to the object.

11. The system of claim 10, wherein the object comprises a tripod.

12. The system of claim 10, wherein the object comprises a ring adapted for connecting to a strap.

13. The system of claim 10, wherein the object comprises a holster connected to a belt.

14. The system of claim 10, wherein the object includes a strap, and further including a coupler for connecting the second adapter to a strap.

15. The system of claim 14, wherein the coupler comprises a swivel connector.

16. The system of claim 10, wherein the second adapter comprises at least three apertures adapted for receiving fasteners for connecting to the second adapter to the object or a strap.

17. The system of claim 16, wherein the at least three apertures are adapted for receiving fasteners for connecting to the second adapter to the object or the strap.

18. The system of claim 16, wherein two of the at least three apertures are for connecting to a coupler for forming a channel with the second adapter for engaging the strap, and a third aperture is for connecting to the object.

19-20. (canceled)

21. A quick-release system for connecting a camera to an object or a strap, comprising:
a first adapter adapted for connecting to the camera; and
a second adapter adapted for forming a releasable locking engagement with the first adapter, the second adapter including at least three apertures adapted for receiving fasteners for connecting to the second adapter to the object or the strap.

22. The system of claim 21, wherein two of the at least three apertures are for connecting to a coupler for forming a channel with the second adapter for engaging the strap, and a third aperture is for connecting to the object.

23-24. (canceled)

25. A quick-release system for connecting a camera with an object, comprising:
a first adapter adapted for connecting to the camera using a first thumb screw; and
a second adapter adapted for forming a releasable locking engagement with the first adapter, the second adapter including at least one aperture for receiving a second thumb screw for connecting the second adapter to the object.

26. A quick-release system, comprising:
a camera including a first threaded aperture for receiving a first fastener;
a first part adapted for connecting to the camera via the first fastener;
a second part adapted for forming a releasable locking engagement with the first part, the second part including a second threaded aperture repeating the functionality of the first threaded aperture of the camera.

27-29. (canceled)
